(19) United States
(12) Patent Application Publication
(10) Pub. No.: US 2003/0093174 A1
(43) Pub. Date: May 15, 2003

(54) Fabrication process control system emulator

(76) Inventor: Serge Nikulin, San Jose, CA (US)

Correspondence Address: Applied Materials Inc, Patent Counsel MS 2061, Legal Affairs Department, 3050 Bowers Avenue, Santa Clara, CA, 95054, US

(21) Appl. No.: 10/149,618

(22) PCT Filed: Dec. 13, 2000
(86) PCT No.: PCT/US00/42782

(51) Int. Cl. G06F 19/00

(52) U.S. Cl. 700/121

(57) ABSTRACT

An emulator is provided that may simulate both software and hardware functions of a fabrication process control system. In a first embodiment, the emulator includes (1) a graphical user interface (GUI) emulator portion adapted to emulate a GUI of a fabrication process control system; (2) a central processing unit (CPU) emulator portion adapted to communicate with the GUI emulator portion and adapted to emulate a CPU of the fabrication process control system; and (3) a harware emulator portion adapted to communicate with the GUI emulator portion and with the CPU emulator portion, and adapted to emulate at least one hardware device employed by the fabrication process control system. Other embodiments also are provided.

The present application claims priority from U.S. Provisional Patent Application Serial No. 60/170,627, filed Dec. 14, 1999, which is hereby incorporated by reference herein in its entirety.

### FIELD OF THE INVENTION

The present invention relates to device fabrication and more particularly to an emulator for emulating a fabrication process control system employed during semiconductor device fabrication, flat panel display fabrication and the like.

### BACKGROUND OF THE INVENTION

Numerous fabrication processes are employed during the fabrication of semiconductor devices. Such processes include deposition, etching, annealing, patterning, etc. Typically, numerous semiconductor device fabrication processes are performed within a single fabrication tool (such as the Precision 5000™, the Producer™, the Endura™ or the Centura™ each of which is manufactured by Applied Materials, Inc.) that comprises a plurality of processing chambers coupled to a transfer chamber. The transfer chamber of the fabrication tool contains a wafer handler that transfers wafers to and from the processing chambers.

To control the various processes performed within a fabrication tool, the fabrication tool is provided with a fabrication process control system (hereinafter “control system”). The control system comprises hardware (e.g., microprocessors, video adapters, input/output devices, clocks, etc.) and software (i.e., control software) which control the operation of the fabrication tool (e.g., loading semiconductor wafers into the fabrication tool, transferring semiconductor wafers to various processing chambers within the fabrication tool, etc.), as well as the operation of the various processing chambers within the tool (e.g., process gas flow rates, wafer biases, etch or deposition times, etc.)

Because of the numerous hardware components that must be controlled by a fabrication tool's process control system, the control software within such a system (e.g., Applied Materials' Legacy software) conventionally is executable only via the fabrication tool. Therefore, the creation, maintenance and/or analysis of new recipes and process sequences to be performed within the fabrication tool, the training of new users, and the analysis of system constants (e.g., wafer size), history logs (e.g., wafer history, faults, etc.) and event logs (e.g., start-up, shut-down, alarm conditions, etc.) can only be performed by employing the fabrication tool. Valuable fabrication tool production time thereby is consumed during these tasks.

Accordingly, a need exists for a method and apparatus for executing the control software of a fabrication tool without requiring the use of the fabrication tool.

### SUMMARY OF THE INVENTION

To address the needs of the prior art, a novel emulator is provided that may simulate both software and hardware functions of a fabrication process control system.

In a first embodiment, the inventive emulator includes (1) a graphical user interface (GUI) emulator portion adapted to emulate a GUI of a fabrication process control system; (2) a central processing unit (CPU) emulator portion adapted to communicate with the GUI emulator portion and adapted to emulate a CPU of the fabrication process control system; and (3) a hardware emulator portion adapted to communicate with the GUI emulator portion and with the CPU emulator portion, and adapted to emulate at least one hardware device employed by the fabrication process control system. Other embodiments also are provided.

As described below, embodiments of the inventive emulator may allow the actual control software of a fabrication tool to be executed by the emulator. The emulator may run on a computer separate and/or remote from the fabrication tool without requiring use of the fabrication tool. Control software (e.g., recipe and sequence files) may be created, edited and maintained using the inventive emulator and thereafter the control software may be employed to control a fabrication tool. Additionally, system constants (e.g., wafer size), history logs (e.g., wafer history) and event logs (e.g., start-up, shut-down, alarm conditions, faults, etc.) may be viewed via the emulator offline from the fabrication tool (e.g., on a personal computer). Data regarding one or more fabrication processes performed with a fabrication tool may be captured via the fabrication tool and analyzed offline via the inventive emulator. The emulator may be used as a training tool without concern of damage to the fabrication tool by an inexperienced user Fabrication tool throughput analysis and optimization similarly may be performed off-line from the fabrication tool. Multitudinous fabrication tool operations thereby may be performed without consuming valuable production time.

Numerous hardware components within a fabrication tool may be emulated by the inventive emulator. For example, the inventive emulator may emulate factory automation interfaces, light pen interfaces, video adapters (e.g., VGA adapters), address spaces, RAM, ROM, dual universal asynchronous receiver-transmitters (DUARTs), clocks, system console interfaces (e.g., LED panels), digital or analog inputs/outputs, various controllers and the like.

Other features and advantages of the present invention will become more fully apparent from the following detailed description, the appended claims, and the accompanying drawings.

### BRIEF DESCRIPTION OF THE DRAWINGS

FIG. 1 is a schematic diagram of a Centura™ fabrication tool manufactured by Applied Materials, Inc.;

FIG. 2 is a schematic diagram of a computer adapted to execute a fabrication process control system emulator in accordance with the present invention;

FIG. 3 is a schematic diagram of an inventive control system emulator configured in accordance with the present invention;

FIG. 4 is a schematic diagram of an exemplary graphical user interface for the control system emulator of FIG. 3;

FIG. 5 is a schematic diagram of an instruction code execution scheme that may be employed by the control system emulator of FIG. 3;

FIG. 6 illustrates an exemplary memory banking scheme that may be employed by the control system emulator of FIG. 3;

FIG. 7 is a flowchart of an exemplary control flow of the control system emulator of FIG. 3;

FIG. 8 is a flowchart of an exemplary control flow of the CPU emulator portion of FIG. 3; and

FIG. 9A and FIG. 9B are flowcharts of the control flow of exemplary opcode instruction functions for memory get and put operations, respectively, that may be executed by the control system emulator of FIG. 3.

### DETAILED DESCRIPTION

In accordance with the present invention, a novel emulator is provided that simulates both software and hardware functions of a fabrication process control system. For convenience, the present invention is described with regard to the Centura™ semiconductor device processing tool manufactured by Applied Materials, Inc. However, it will be understood that any other fabrication processing tool or system may be similarly emulated.

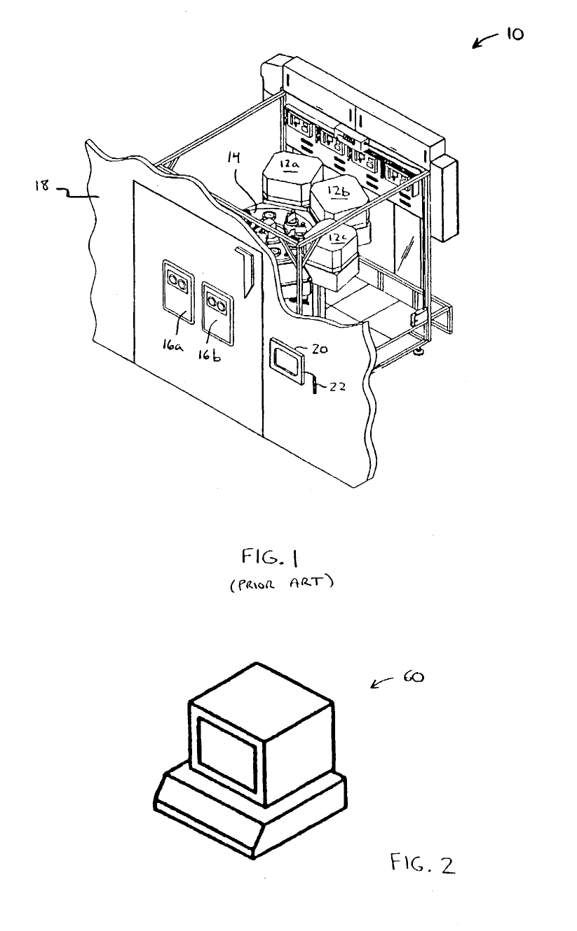

FIG. 1 illustrates a Centura™ fabrication tool 10 manufactured by Applied Materials, Inc. As shown in FIG. 1, the Centura™ comprises a plurality of processing chamber 12a-c coupled to a transfer chamber 14. The Centura™ is provided with two loadlocks 16a-b for loading wafers into and out of the transfer chamber 14 via a wafer handler (not shown) located within the transfer chamber 14. The wafer handler (not shown) may transfer semiconductor wafers between the loadlocks 16a-b and the processing chambers 12a-c, as is well known in the art. Typically the Centura™ is located behind a cleanroom wall 18 through which the doors of the loadlocks 16a-b extend.

To control the various processes performed within the Centura™ (e.g., loading/unloading operations between the loadlocks 16a-b and the transfer chamber 14, transfer operations between the transfer chamber 14 and one or more of the processing chamber 12a-c, processing within the processing chambers 12a-c, etc.), the Centura™ is provided with a fabrication process control system (“control system”) that includes hardware (e.g., microprocessors, video adapters, input/output devices, clocks, etc.) and software (i.e., control software). To interact with the control system of the Centura™ (e.g., for creation, maintenance and/or analysis of new recipes and process sequences, for training purposes, for analysis of system constants, etc.), a user typically employs a cathode-ray tube (CRT) monitor 20 that is controllable via a lightpen 22 as shown in FIG. 1.

As stated previously, because of the numerous hardware components that must be controlled by a control system of a fabrication tool such as the Centura™, the control software within such a system (e.g., Applied Materials' Legacy software) conventionally is executable only via the fabrication tool. Therefore, the creation, maintenance and/or analysis of new recipes and process sequences to be performed within the fabrication tool, the training of new users, and the analysis of system constants (e.g., wafer size), history logs (e.g., wafer history, faults, etc.) and event logs (e.g., start-up, shut-down, alarm conditions, etc.) can only be performed by employing the fabrication tool. Valuable fabrication tool production time thereby is consumed during these tasks.

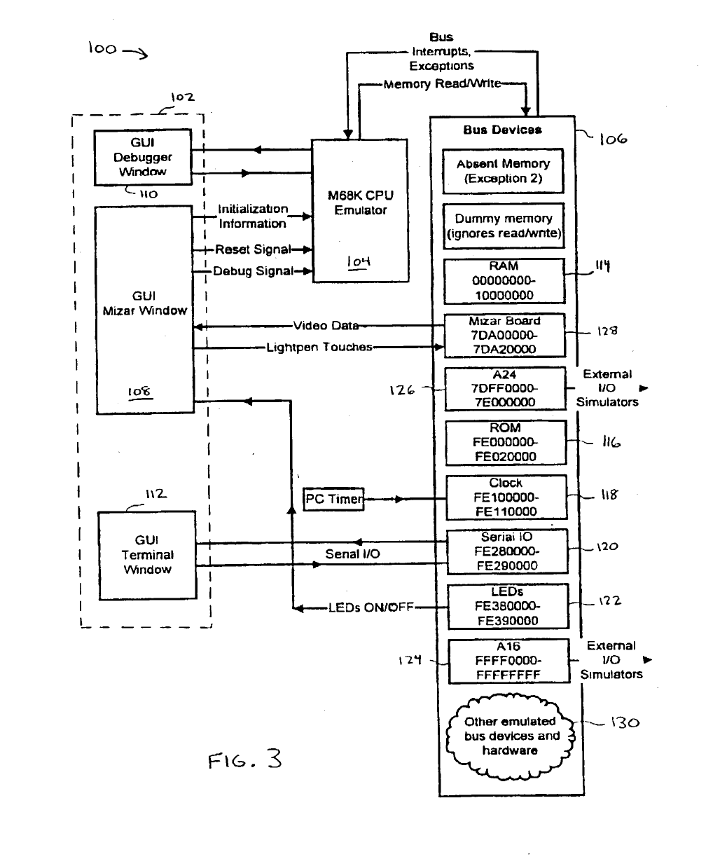

In accordance with the present invention, rather than employing the fabrication tool itself for the creation, maintenance and/or analysis of new recipes and process sequences to be performed within the fabrication tool, the training of new users, and the analysis of system constants, history logs and event logs, these tasks may be performed on a computer system such as on the personal computer 60 shown in FIG. 2 (e.g., a laptop, a desktop or another similar computer) that stores and executes a computer program code representation of the inventive emulator (as described below). Valuable fabrication tool production time thereby is not consumed during these tasks.

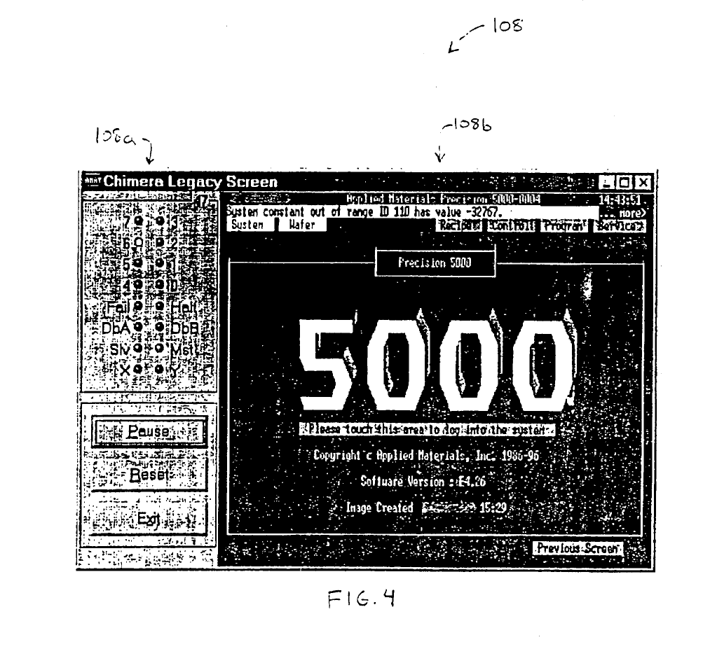

FIG. 3 is a schematic diagram of an inventive control system emulator 100 configured in accordance with the present invention. The control system emulator 100 may comprise a computer program product carried by a medium readable by a computer (e.g., a carrier wave signal, a floppy disc, a hard drive, a random access memory, etc.) and that is executable by a computer (e.g., such as the computer 60 of FIG. 2). In one embodiment of the invention, the control system emulator 100 includes a graphical user interface (GUI) emulator portion 102, a computer processing unit (CPU) emulator portion 104 and a hardware emulator portion 106 as shown in FIG. 3. Other configurations also may be employed. Note that the GUI emulator portion 102, the CPU emulator portion 104 and the hardware emulator portion 106 are shown schematically as separate units for convenience only and may comprise intermingled computer program code.

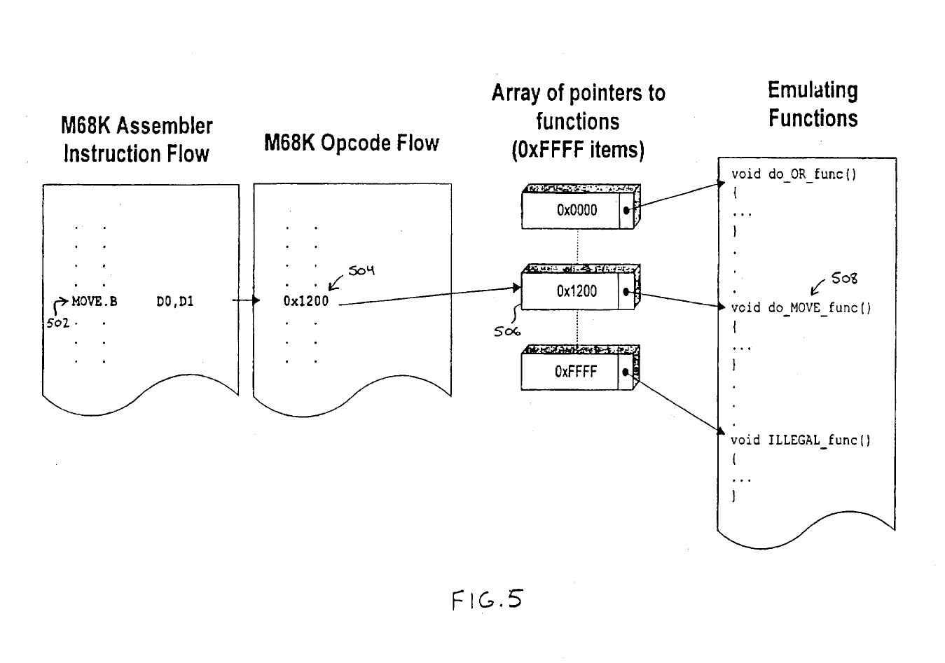

The GUI emulator portion 102 comprises computer program code which emulates the user interface of the control system being emulated. For example, if the control system of an Applied Materials, Inc. Centura™ is being emulated, the GUI emulator portion 102 preferably emulates the user interface used by the Centura™ (e.g., the Mizar GUI 108 as shown in FIG. 3 and FIG. 4 including both hardware interfaces such as a hardware panel of LEDs 108a and software interfaces such as a software interface 108b). The GUI emulator portion 102 also may comprise a GUI debugger window 110 that allows for low level debugging and a GUI terminal window 112 that allows for a real time operating system interface (e.g., Applied Materials' Boss operating system). For example, the GUI debugger window 110 may interface with the CPU emulator portion 104, and allow a software developer to “freeze” execution and CPU state of the emulated CPU (e.g., for analysis purposes). The GUI terminal window 112, for example, may provide a serial interface that allows real time monitoring of emulated fabrication tool operations for configuration purposes (e.g., similar to the serial interface provided on the Centura™ for providing real time process information to process engineers).

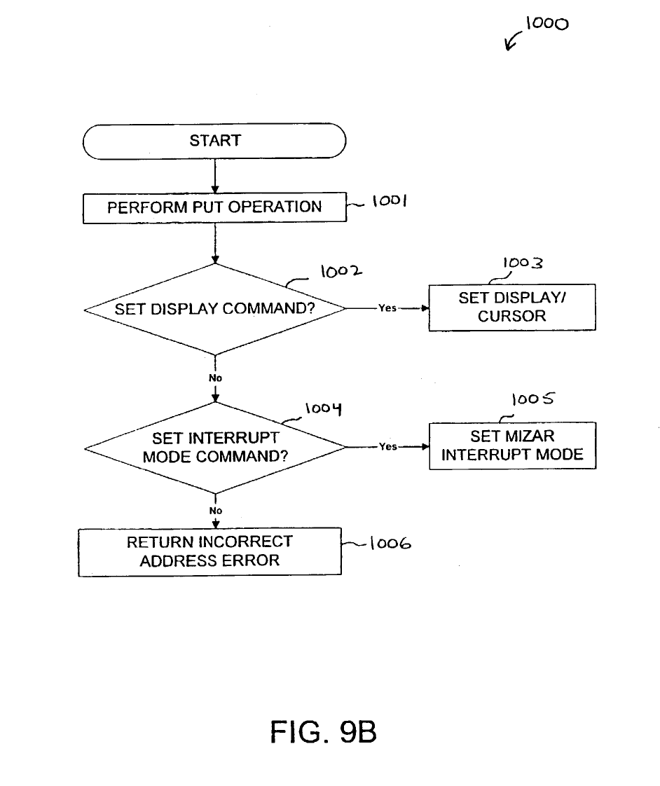

Note that the particular computer program code used to implement the GUI emulator portion 102 depends on which GUI is being emulated (e.g., the Mizar GUI of the Centura™, or some other GUI), and that, in general, a person of ordinary skill in the art can develop computer program code necessary to emulate any GUI (or any CPU or hardware) of any fabrication process control system. The Mizar GUI 108 may be embodied, for example, using external calling programs (e.g., drive-by-calls), and read and write operations may be employed, for example, using the functions described below with reference to FIGS. 9A and 9B.

The CPU emulator portion 104 comprises computer program code which emulates the particular CPU which controls the control system being emulated. In the example of FIG. 3, the CPU emulator portion 104 comprises the Motorola 68040 CPU emulator, and in one embodiment of the invention emulates the entire set of 68040 instructions excluding memory management unit (MMU) instructions. Alternatively, a portion of the set of 68040 instructions may be emulated, and/or the MMU instructions may be emulated. The CPU emulator portion 104 interfaces with the GUI emulator portion 102, allowing the GUI emulator portion 102 to transmit information therebetween such as initialization information (e.g., a display of diagnostic start-up information), a reset signal (e. g., to reset the CPU), debug signals (e.g., interrupts), etc.

The hardware emulator portion 106 comprises computer program code which emulates the various hardware (e.g., bus devices) associated with the control system being emulated. Exemplary emulatable hardware includes factory automation interfaces, light pen interfaces, video adapters (e.g., VGA adapters), address spaces, RAM, ROM, dual universal asynchronous receiver-transmitters (DUARTs), clocks, system console interfaces (e.g., LED panels), digital or analog inputs/outputs, various controllers and the like. In the control system emulator 100 of FIG. 3, the hardware emulator portion 106 comprises computer program code which emulates, for example, the basic components of the Synergy-V452™ board produced by Synergy Microsystems' of San Diego, Calif. (e.g., RAM 114, ROM 116, clock 118, serial I/O 120, LEDs 122, A16-A24 address space as represented by reference numerals 124 and 126, etc.), a video VGA adapter (e.g., with two DUARTs and 128 Kbyte CMOS memory) that forms part of the Mizar board 128, as well as a 16 Mbyte RAM, a 128 Kbyte ROM, standard DUARTs (e.g., with a heart-beat counter), a real-time clock, an LED panel, a shared memory to interface other CPUs in the system to the Motorola 68040 processor, device net devices, HSMS devices, Synergy's ethernet/SCSI/serial equipment (ESSE) address space, etc. (all of which are represented generally by reference numeral 130).

The control system emulator 100 may further emulate serial data transfers between the GUI terminal window 112 and the hardware emulator portion 106, LED information (e.g., information regarding whether the LEDs within an emulated console should be ON or OFF) which is transmitted between the MIZAR GUI 108 and the hardware emulator portion 106, interrupts and exceptions generated by the hardware emulator portion 106 and communicated to the CPU emulator portion 104, light pen touches from the MIZAR GUI 108 to the hardware emulator portion 106, video data transfers between the MIZAR GUI 108 and the hardware emulator portion 106, and external I/O simulators (e.g., Semi Equipment Communication Standard (SECS) Simpro produced by G. W. Associates of Santa Clara County, Calif.). In at least one embodiment of the invention, the operating system of the control system emulator 100 is based on the operating system employed by the control system being emulated (e.g., Applied Materials' BOSS E4.8 operating system). In the exemplary embodiment of FIG. 3, the control system emulator 100 emulates sufficient hardware and software to allow the control system emulator 100 to execute Applied Materials' Legacy software on a personal computer (e.g., the computer 60 of FIG. 2).

In operation, embodiments of the control system emulator 100 may execute the actual control software which controls the control system being emulated. The control system emulator 100 may execute control software instruction-by-instruction or in any other suitable manner (e.g., a multi-processor system may be employed to affect the execution of instructions in parallel). For example, in one embodiment of the invention, a C++ function is created for each instruction op-code employed within the CPU emulator portion 104. It will be understood that any other computer language may be similarly employed such as assembly, Visual Basic, etc.

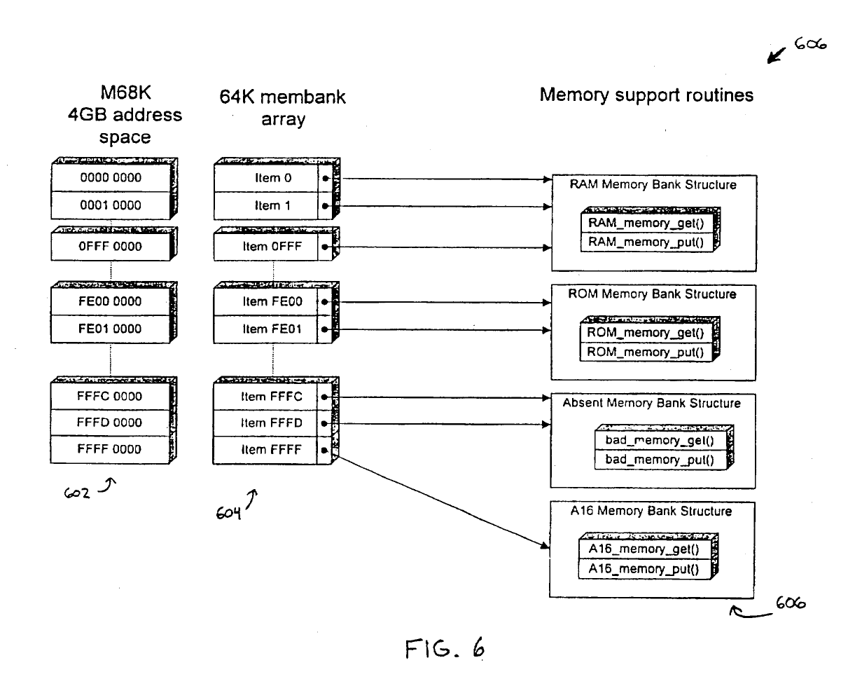

In an embodiment wherein a Motorola 68040 (M68K) CPU is employed, instructions can be identified by the first 16 bits of each op-code instruction because all M68K instructions have a length of at least 16 bits. To increase the speed at which code may he executed by the control system emulator 100, an 0xFFFF length array of pointers to emulating functions (e.g., C++ functions) may be provided as shown in FIG. 5. With reference to FIG. 5, the first sixteen bits of each M68K op-code instruction are used to address an array location containing a pointer to a function which emulates the M68K op-code instruction. Each emulating function determines the full length of the respective op-code instruction (e.g., if the op-code instruction requires additional data bits) and reads any required data that follows the op-code instruction. Each emulating function then performs any operations associated with the op-code instruction.

As an example, with reference to FIG. 5, assume that an assembler instruction MOVE.B DO, D1 (identified by reference numeral 502 in FIG. 5) is to be executed by the control system emulator 100. The instruction MOVE.B DO, D1 corresponds to opcode 0x1200 (identified by reference numeral 504 in FIG. 5). The first sixteen bits of the opcode 0x1200 are examined and are used to address an array location (identified by reference numeral 506 in FIG. 5) containing a pointer to the appropriate emulating function (identified by reference numeral 508 in FIG. 5). As another example, if the control system emulator 100 executes control software which contains a set bit (BSET) instruction (e.g., 08C0 00XX in op-code form), the first sixteen bits of the op-code instruction serve as an array address 08C0. The array address 08C0 contains a pointer to a function which emulates the BSET command:

| void_08C0 (U_LONG opcode) /*BSET*/ | |
|---|---|
| { | |
| | U_LONG dstreg = opcode & 7; |
| {{ | S_WORD src = get_next_word() ; |
| { | S_LONG dst = m68k_dreg(cpu, dstreg); |
| | src &= 31; |
| | ZFLG = !(dst & (1 << src)); |
| | dst != (1 << src); |
| | m68k_dreg(cpu, dstreg) = (dst); |
| }}}} | |

Accordingly, the control system emulator 100 calls this function each time it receives an op-code instruction having 0x08C0 as its first sixteen bits.

The M68K CPU employs a 32 bit address or a 4 Gbyte memory space. Accordingly, in an embodiment of the control system emulator 100 wherein the M68K CPU is emulated, the control system emulator 100 should be able to emulate a 4 Gbyte memory space. Because many personal computers lack sufficient memory space for directly emulating a 4 Gbyte memory space, a “memory-banking” scheme may be employed by the control system emulator 100.

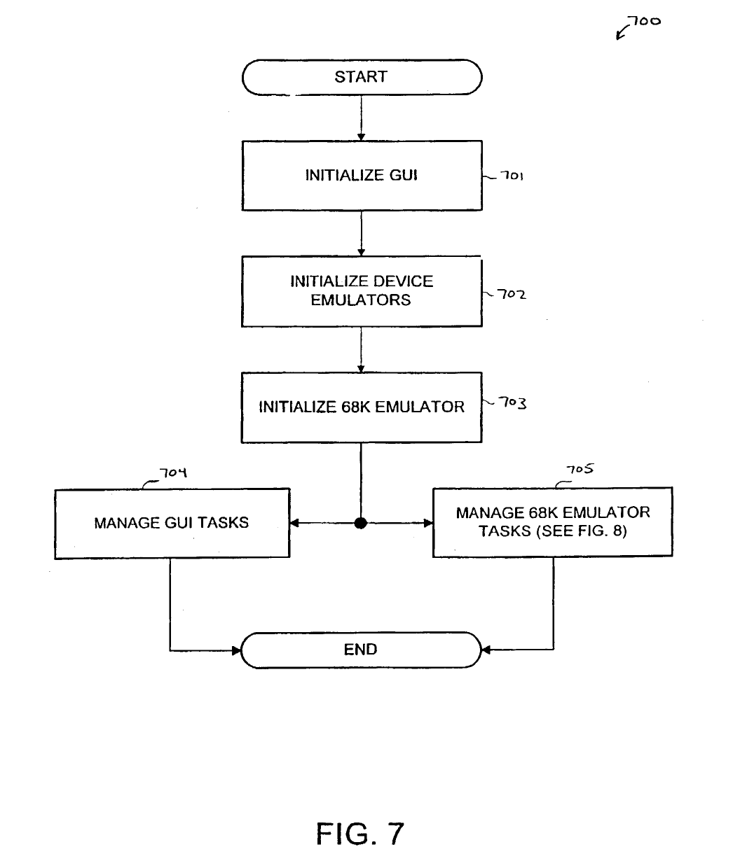

FIG. 6 illustrates an exemplary memory banking scheme 400 that may be employed by the control system emulator 100. With reference to FIG. 6, the M68K 4 Gbyte memory space is represented by reference numeral 602. To emulate this 4 Gbyte memory space, the control system emulator 100 may be provided with a memory bank array 604 of 65,536 (64×1024 or 64K) elements which contains pointers to various memory get and memory put functions 606. To perform memory functions, the upper sixteen bits of each 32 bit address of the M68K CPU are used to address the memory bank array of 65,536 elements and to access the contents of the 64 Kbyte blocks of memory. Each addressable location of the 64 Kbyte blocks of memory is provided with a pointer to a memory support routine which handles the memory get and put functions associated with the address space identified by the original 32 bit address. Accordingly, the memory-banking banking scheme allows memory processing functions of the entire 4 Gbyte memory space of the M68K CPU to be managed via one memory bank array of 65,536 elements.

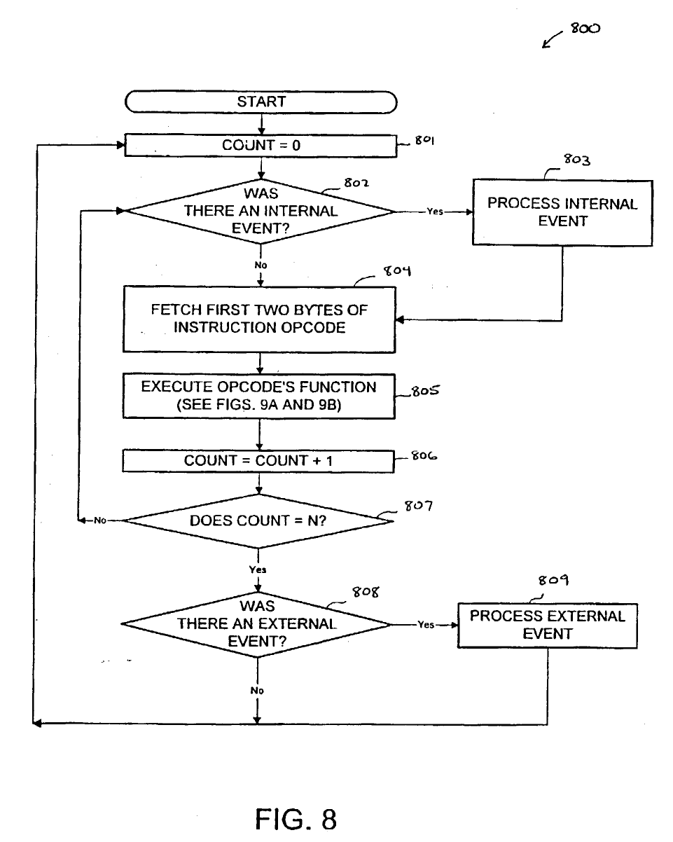

FIG. 7 is a flowchart of an exemplary control flow 700 of the control system emulator 100. With reference to FIG. 7, in step 701 the MIZAR GUI 108, the GUI debugger window 110 and the GUI terminal window 112 are initialized, in step 702 the hardware/device emulators (within the hardware emulator portion 106) are initialized and in step 703 the CPU emulator portion 104 is initialized. For example, during GUI initialization (step 701), the control system emulator 100 may create and size the Mizar GUI window, the GUI debugger window and the GUI terminal window. The control system emulator 100 also may create the thread for the CPU emulator 108.

During initialization of the device emulators (step 702), the control system emulator 100 may load all needed devices (e.g., all needed device code), and then call initialization procedures for each device. The control system emulator 100 also may assign memory support routines to a memory bank array (as described previously with reference to FIG. 6). For example, during initialization, the A16 memory device (FIG. 3) may assign its memory support routines to memory bank array items beginning from item 0xFFFD to 0xFFFF. Thereafter, every device may “register” its own setup dialogs (e.g., to allow each device to be “fine-tuned” later). Each device may also indicate whether it will ever produce hardware interrupts (e.g., so that the control system emulator 100 knows to periodically check the state of the device).

During initialization of the 68K emulator (step 703), the control system emulator 100 may initialize all internal tables (e.g., the array of pointers to functions as described previously with reference to FIG. 5). The control system emulator 100 also may place the 68K emulator in a RESET state (e.g., wherein all CPU flags are zeroed, initial program counters are set to predefined values, the initial stack pointer is assigned a ROM base address, etc.). Note that steps 701-703 may be performed in any order.

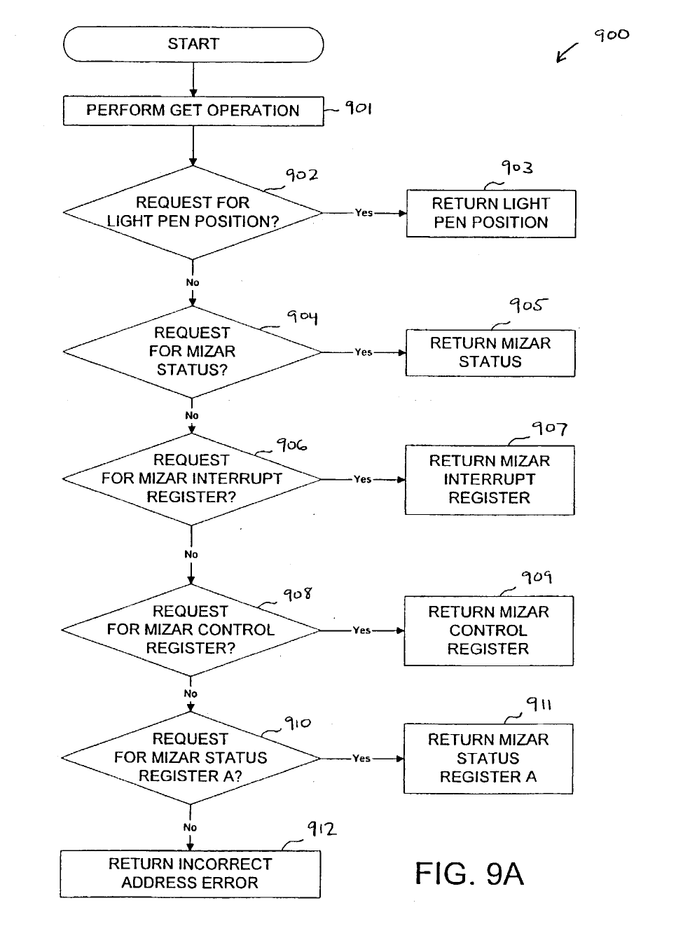

Following steps 701-703, the control system emulator 100 simultaneously manages GUI tasks (step 704) and emulator tasks (step 705). With regard to the Mizar GUI window 108, GUI task management (step 704) may include, for example, performing main user interface functions, scanning the memory of each device (e.g., within the hardware emulator portion 106) and displaying the contents as an image, receiving mouse clicks, translating the mouse clicks into light pen touches and sending the mouse clicks to the hardware emulator portion 106, etc. GUI task management with regard to the GUI debugger window 110 may include, for example, allowing a user to stop emulation at any moment and analyze the state of the CPU and devices and emulated hardware. With regard to the GUI terminal window 112, GUI task management may include receiving and displaying signals from an emulated serial channel of the hardware emulator portion 106, receiving user keyboard input and sending the keyboard input to the hardware emulator portion 106 via the emulated serial channel, etc Management of emulator tasks (step 705) is described below with reference to FIG. 8.

FIG. 8 is a flowchart of an exemplary control flow 800 of the CPU emulator portion 104 during step 705 of the process 700 of FIG. 7. In general, step 705/process 800 represents an infinite loop which constantly fetches, interprets and executes op-code instructions provided to the control system emulator 100 (e.g., from control software that runs on a fabrication tool and that is executed by the emulator) and handles internal events (e.g., trace, debug, interrupt, reset or stop commands from the GUI emulator portion 102 or from the emulated hardware) and external events (e.g., device interrupts) as shown.

With reference to FIG. 8, the process 800 begins in step 801 wherein the CPU emulator portion 104 sets a counter (COUNT) to zero. In step 802, the CPU emulator portion 104 determines whether an internal event has occurred. For example, the CPU emulator portion 104 may determine whether a CPU internal flag has been raised indicating that an interrupt, a trace, a debug request, a reset request, a stop request or the like has occurred. If an internal event has occurred, in step 803, the CPU emulator portion 104 processes the internal event (e.g., by calling the corresponding interrupt or other routine within the available emulated functions described previously with reference to FIG. 5), and the process 800 then proceeds to step 804. Otherwise, if no internal event has occurred (as determined in step 802), the process 800 proceeds to step 804.

In step 804, the CPU emulator portion 104 fetches the first two bytes of instruction opcode from the computer than is executing the inventive control system emulator 100. Thereafter, in step 805 the CPU emulator portion 104 executes the opcode's function (as described below with reference to FIGS. 9A and 9B).

In step 806, the CPU emulator portion 104 increments COUNT; and in step 807, the CPU emulator portion 104 determines if COUNT has reached a pre-determined number N. Note that “N” represents a factor used by the inventive control system emulator 100 to match; or approximately match) the speed of an M68K CPU to the speed of the CPU of the computer on which the inventive control system emulator 100 is executed. For example, the CPUs of most personal computers operate significantly faster than the M68K CPU. In order for the emulator 100 to operate at the same speed as the fabrication process control system being emulated, the emulator 100 typically must delay the polling of emulated devices/hardware (as described below) for several clock cycles. This delay may be achieved by performing steps 802-807 “N” times. N may be determined based on a “rough” or an “average” estimate of CPU speed, or N may be determined at initialization of the emulator by performing a calibration procedure that determines the actual speed of the CPU executing the inventive emulator 100, and by calculating N based thereon. Alternatively, the N count loop (steps 801, 806 and 807) may be eliminated, and the CPU executing the inventive emulator 100 may check the emulated devices/hardware for interrupts at the appropriate time (e.g., by using the CPU's own counters and interrupts). With reference to step 807 in FIG, 8, if COUNT has not reached N, the process 800 returns to step 802 to determine if an internal event has occurred (as described above); otherwise, if COUNT has reached N, the process 800 proceeds to step 808.

In step 808, the CPU emulator portion 104 determines whether an external event has occurred (e.g., whether a device interrupt has occurred). The CPU emulator portion 104 may calculate/perform emulating functions for a pre-determined time period (e.g., 10 msec) before polling external devices (emulated via the hardware emulator portion 106) regarding their state (e.g., to determine if any devices have generated an interrupt). Likewise, external devices (emulated via the hardware emulator portion 106) may directly indicate an interrupt state without being polled. If in step 808, the CPU emulator portion 104 determines that an external event has not occurred, the process 800 returns to step 802 to determine if an internal event has occurred (as described above); otherwise, if an external event has occurred, the process 800 proceeds to step 809 wherein the CPU emulator portion 104 processes the external event (e.g., processes the interrupt). Following step 809, the process 800 returns to step 801 to reset COUNT to zero and then to determine if an internal event has occurred in step 802 (as described above).

FIG. 9A and FIG. 9B are flowcharts of the control flow of exemplary op-code instruction functions for memory get (process 900 in FIG. 9A) and memory put operations (process 1000 in FIG. 9B), respectively, that may be executed by the control system emulator 100 of FIG. 3 (e.g., during step 805 of the process 800 of FIG. 8). For convenience, the control flow of FIGS. 9A and 9B is described with reference to the Centura™ and the Mizar GUI. However, it will be understood that similar processes may be performed for other fabrication tools and/or for other GUIs.

With reference to FIG. 9A, in step 901, the GUI emulator portion 102 generates a get instruction (e.g., device_mem_get_long(address)). In step 902, the CPU emulator portion 104 determines whether the get instruction is a request for light pen position (e.g., whether the address represents a MIZAR_PEN_CONFIRM request). If so, in. step 903, the hardware emulator portion 106 returns light pen position information to the GUI emulator portion 102; otherwise the process 900 proceeds to step 904.

In step 904, the CPU emulator portion 104 determines whether the get instruction is a request for Mizar status (e.g., whether the address represents a MIZA_VDC_STC request). If so, in step 905, the hardware emulator portion 106 returns Mizar status information (e.g., whether the cursor is enabled/disabled, etc.) to the GUI emulator portion 102; otherwise the process 900 proceeds to step 906.

In step 906, the CPU emulator portion 104 determines whether the get instruction is a request for the contents of the Mizar interrupt register (e.g., whether the address represents a MIZAR_D1ADDR_SR request) If so, in step 907, the hardware emulator portion 106 returns the contents of the Mizar interrupt register to the GUI emulator portion 102; otherwise the process 900 proceeds to step 908.

In step 908, the CPU emulator portion 104 determines whether the get instruction is a request for the contents of the Mizar control register (e.g., whether the address represents a MIZAR_D1ADDR_IPCR request). It so, in step 909, the hardware emulator portion 106 returns the contents of the Mizar control register to the GUT emulator portion 102; otherwise the process 900 proceeds to step 910.

In step 910, the CPU emulator portion 104 determines whether the get instruction is a request for the contents of the Mizar status register A (e.g., whether the address represents a MIZAR_D1ADDR_SRA request) If so, in step 911, the hardware emulator portion 106 returns the contents of the Mizar status register A to the GUI emulator portion 102; otherwise the process 900 proceeds to step 912 wherein an incorrect address error is returned to the GUI emulator portion 102.

With reference to FIG. 9B, in step 1001, the GUI emulator portion 102 generates a put instruction (e.g., device_mem_put_long(address, value)). In step 1002, the CPU emulator portion 104 determines whether the put instruction is a command to affect the set up of the Mizar display (e.g., a command to change cursor shape, such as an address that represents a MIZAR_VDC_STC command). If so, in step 1003, the hardware emulator portion 106 changes the display/cursor size of the emulated Mizar display (e.g., based on the put value); otherwise the process 1000 proceeds to step 1004.

In step 1004, the CPU emulator portion 104 determines whether the put instruction is a command to set the Mizar interrupt mode (e.g., whether the address represents a MIZAR_D1ADDR_MR command) If so, in step 1005, the hardware emulator portion 106 sets the Mizar interrupt mode (e.g., based on the put value); otherwise the process 1000 proceeds to step 1006 wherein an incorrect address error is returned to the GUI emulator portion 102. Numerous other get and put operations may be similarly performed.

Note that by employing the inventive emulator 100, a user may perform numerous functions. For example, control software (e.g., recipe and sequence files) may be created, edited and maintained using the inventive emulator and thereafter the control software may be employed to control a fabrication tool. Additionally, system constants (e.g., wafer size), history logs (e.g., water history) and event logs (e.g., start-up, shut-down, alarm conditions, faults, etc.) may be viewed via the emulator offline from the fabrication tool (e.g., on the personal computer 60 of FIG. 2). Data regarding one or more fabrication processes performed with a fabrication tool may be captured via the fabrication tool and analyzed offline via the inventive emulator. The emulator may be used as a training tool without concern of damage to the fabrication tool by an inexperienced user. Fabrication tool throughput analysis and optimization similarly may be performed off-line from the fabrication tool. Numerous fabrication tool operations thereby may be performed without consuming valuable production time. Additionally, in certain embodiments of the invention, the actual control software that controls a fabrication tool may be executed using the inventive emulator 100 (e.g., the control software of the fabrication tool will have no ability detect whether it is being executed by the fabrication tool or by the emulator).

The foregoing description discloses only exemplary embodiments of the invention, modifications of the above-disclosed apparatus and method which fall within the scope of the invention will be readily apparent to those of ordinary skill in the art. For instance, while the control system emulator 100 has been described primarily with respect to the Motorola M68K CPU, it will be understood that any other processor may be similarly employed and emulated (e.g., a Motorola Power PC Processor (PPC), an Intel Processor, etc.)).

Accordingly, while the present invention has been disclosed in connection with exemplary embodiments thereof, it should be understood that other embodiments may fall within the spirit and scope of the invention, as defined by the following claims.

The invention claimed is:

1. A method of emulating a fabrication process control system comprising:
emulating a graphical user interface (GUI) of a fabrication process control system;
emulating a central processing unit (CPU) of the fabrication process control system; and
emulating at least one hardware device employed by the fabrication process control system.

2. The method of claim 1 wherein the fabrication process control system comprises a fabrication process control system of a semiconductor device manufacturing tool.

3. The method of claim 1 further comprising at least one of creating, editing and maintaining control software of the fabrication process control system based on at least one of the emulated GUI, the emulated CPU and the emulated at least one hardware device.

4. The method of claim 3 wherein the control software comprises at least one of a recipe for a semiconductor device manufacturing tool and a sequence file for the semiconductor device manufacturing tool.

5. The method of claim 1 further comprising employing at least the emulated GUI to view at least one of a system constant, a history log and an event log of a semiconductor device manufacturing tool.

6. The method of claim 1 further comprising employing at least one of the emulated GUI, the emulated CPU and the emulated at least one hardware device to analyze data captured from a fabrication tool.

7. The method of claim 1 further comprising employing at least one of the emulated GUI, the emulated CPU and the emulated at least one hardware device to train a user of a fabrication tool.

8. The method of claim 1 further comprising employing at least one of the emulated GUI, the emulated CPU and the emulated at least one hardware device to analyze a throughput of a fabrication tool.

9. The method of claim 1 wherein the at least one hardware component comprises at least one of a factory automation interface, a light pen interface, a video adapter, an address space, a random access memory, a read only memory, a dual universal asynchronous receiver transmitter, a clock, a system console interface, a digital input, a digital output, an analog input, an analog output and a controller.

10. A fabrication process control system emulator adapted to emulate a fabrication process control system comprising:
a graphical user interface (GUI) emulator portion adapted to emulate a GUI of a fabrication process control system;
a central processing unit (CPU) emulator portion adapted to communicate with the GUI emulator portion and adapted to emulate a CPU of the fabrication process control system; and
a hardware emulator portion adapted to communicate with the GUI emulator portion and with the CPU emulator portion, and adapted to emulate at least one hardware device employed by the fabrication process control system.

11. The system of claim 10 wherein the fabrication process control system comprises a fabrication process control system of a semiconductor device manufacturing tool.

12. A computer program product comprising:
a medium readable by a computer, the computer readable medium having program code adapted to:
emulate a fabrication process control system by emulating:
a graphical user interface (GUI) of the fabrication process control system;
a central processing unit (CPU) of the fabrication process control system; and
at least one hardware device employed by the fabrication process control system.

13. The computer program product of claim 12 wherein the fabrication process control system comprises a fabrication process control system of a semiconductor device manufacturing tool.
